(19) United States
(12) Patent Application Publication
(10) Pub. No.: US 2016/0184844 A1
(43) Pub. Date: Jun. 30, 2016

(54) ATOMIZER FOR A LUBRICANT PRODUCT AND LUBRICATION SYSTEM COMPRISING SAID ATOMIZER

(71) Applicant: SAMES TECHNOLOGIES, Meylan (FR)

(72) Inventors: Michel Di Gioia, Seyssinet Pariset (FR); Gilles Goisot, Saint Ismier (FR); Benoit-Marc Vedovati, Vizille (FR)

(21) Appl. No.: 14/910,832

(22) PCT Filed: Aug. 12, 2014
(86) PCT No.: PCT/EP2014/067254

§ 371 Date: Feb. 8, 2016

(30) Foreign Application Priority Data
Aug. 13, 2013 (FR) 1357990

(51) Int. Cl. B05B 5/03; B05B 7/10; F16N 7/34; B05B 7/08

(52) U.S. Cl. CPC B05B 5/03; B05B 7/0815; B05B 7/0892; B05B 7/10; F16N 7/34

(57) ABSTRACT

This atomizer makes it possible to spray a lubricant product along a spraying axis and comprises a first passage for the product which is centered on the spraying axis, a nozzle which is centered on the spraying axis, and a core which is disposed coaxially inside the nozzle. The atomizer also comprises a second passage for ejecting a first jet of air, which is arranged around the first passage in a peripheral direction with respect to the spraying axis and which, in operation, confers a helical direction on the first jet of air. In addition, the first passage is defined between the core and the nozzle and is formed by a plurality of separate passage sections.

The invention relates to an atomizer intended for spraying a lubricant on a part, notably via an electrostatic route.

The invention finds an application in the field of lubrication of parts, such as for example metal sheets intended to be formed by stamping, die-forging or further cutting. In this type of method, the metal sheets have to be lubricated in order to prevent any form of heating, of seizure, adhesive bonding or removal of material. Thus, the forming tool and/or the sheet of metal are coated with a lubricant by means of an atomizer of the pneumatic type or further of a coating roller. In a facility for lubricating a part, an atomizer most often comprises a nozzle inside which is positioned a needle which regulates the flow rate of the lubricant, the lubricant being sprayed by the nozzle along a spraying axis.

In an electrostatic lubrication method, the atomizer is provided with an electrode installed inside the nozzle and which is in contact with the lubricant so that the latter is electrostatically charged. An electrostatic field is generated between the part to be lubricated, connected to ground and the atomizer. This electrostatic field gives the possibility of guiding the lubricant particles, themselves electrostatically charged, according to a same polarity from the atomizer as far as the part.

Presently, the accuracy of spraying tools is approximate. The yield of these spraying tools is low since it is necessary to spray significant amounts of lubricant in order to obtain a perfectly lubricated part. In reality, a low proportion, of about 5% of sprayed lubricant is actually effective. This leads to dangerous work environments with a more significant risk of fire and a slippery ground. This also implies that the lubrication workshops are not very clean. Thus, an operator may inhale oil aerosols and develop allergies or diseases. The World Health Organization moreover considers that inhalation and/or contact with lubricants is the first or second cause of professional cancers worldwide. Further, the parts obtained at the end of the stamping, die-forging or cutting method should be cleaned, and an over-consumption of solvent is therefore induced for cleaning and over-consumption of energy for drying the parts.

Further, the atomizers are presently capable of producing a flow rate of the order of 80 cubic centimeters per minute (cm³/min). Now, it is today interesting for certain applications, to be able to lubricate a part with a very low flow rate, i.e. less than 1 cm³/min, and this type of flow rate is presently impossible to achieve with the atomizers on the market.

As an example, US-A-2007/0102841 discloses an atomizer comprising a nozzle, which is centered on a spraying axis and a core, which is co-axially positioned inside the nozzle. The core is crossed by several conduits for letting through a liquid, which open into a ring-shaped volume centered on the spraying axis and allowing ejection of a tubular liquid jet. Holes for letting through a gas, like air, cross the nozzle and are laid out around the passage for the liquid, so that they form a swirling air jet, or <<vortex>>, having a helical direction around the spraying axis.

This atomizer is not designed for producing a very low flow rate and proposing greater spraying fineness.

These are the drawbacks which the invention more particularly intends to remedy by proposing an atomizer giving the possibility of diffusing the lubricant at a low flow rate and with very great spraying fineness.

For this purpose, the invention relates to an atomizer of a lubricant product along a spraying axis, comprising a first passage of the lubricant product which is centered on the spraying axis, a nozzle, which is centered on the spraying axis, a core which is co-axially positioned inside the nozzle, and a second passage for ejecting a first air jet, which is arranged around the first passage along a peripheral direction to the spraying axis, and which, during operation, imparts to the first air jet a helical direction. According to the invention, the first passage is defined between the core and the mozzle and is formed by several disconnected passage sections.

By means of the invention, the disconnected passage sections diffuse the lubricant with a very low flow rate, which improves the spraying yield and reduces the amount of oil required for lubricating a part.

According to advantageous but non-mandatory aspects of the invention, an electrostatic atomizer may incorporate one or several of the following features, taken in any technically admissible combination:
The passage sections have a radial dimension of less than 0.5 mm and preferably of the order of 0.2 mm.
The passage sections of the lubricant product are regularly distributed around the spraying axis.
The passage sections are triangular.
The atomizer further comprises a ring which clasps, at least partly, the core and in that the passage sections of the lubricant product are formed by grooves extending axially over the periphery of the core.
The atomizer comprises a third passage for ejecting a second air jet, which is positioned between the ring and the nozzle.
The third passage is tubular so that, during operation, it gives the second air jet an axial direction.
The second passage for the air is formed by holes which are regularly distributed around the axis and which, during operation, give the first air jet a direction comprising an axial component and an ortho-radial component to the spraying axis.
It further comprises an electrically conducting element positioned in contact with the lubricant product and powered up during the operation of the atomizer.

The invention also relates to a facility for lubricating a part, comprising a confinement chamber, a block for supplying a lubricant product, an electropneumatic control box and at least one atomizer characterized in that the atomizer is as described earlier.

Advantageously, the block for supplying the lubricant product is equipped with a valve for interrupting the flow of the lubricant product towards the atomizer at a frequency comprised between 10 and 200 Hz of the power supply of the atomizer.

The invention will be better understood and other advantages thereof will become more clearly apparent in the light of the description which follows of an embodiment of an atomizer according to its principle, only given as an example and made with reference to the appended drawings wherein:

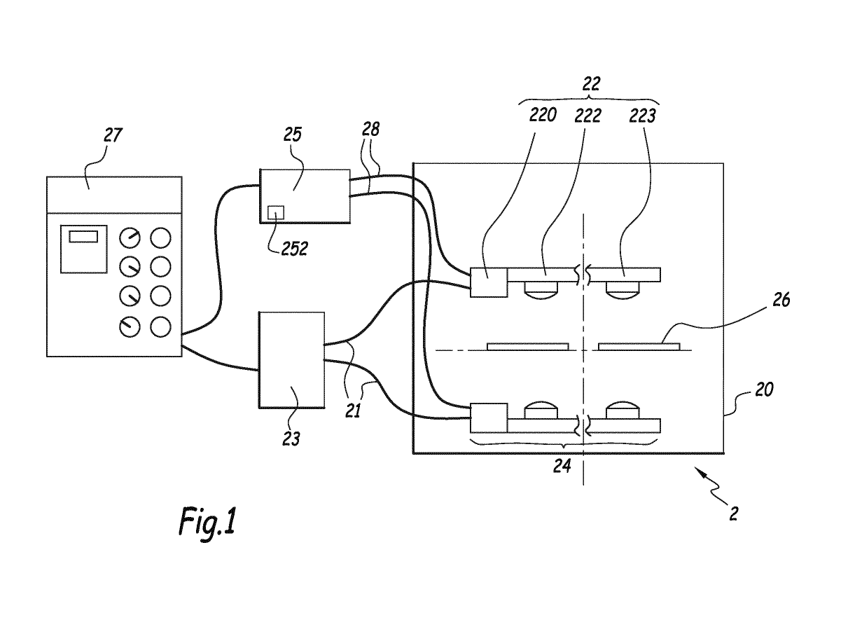

FIG. 1 an overall diagram of a lubrication facility via an electrostatic route according to the invention,

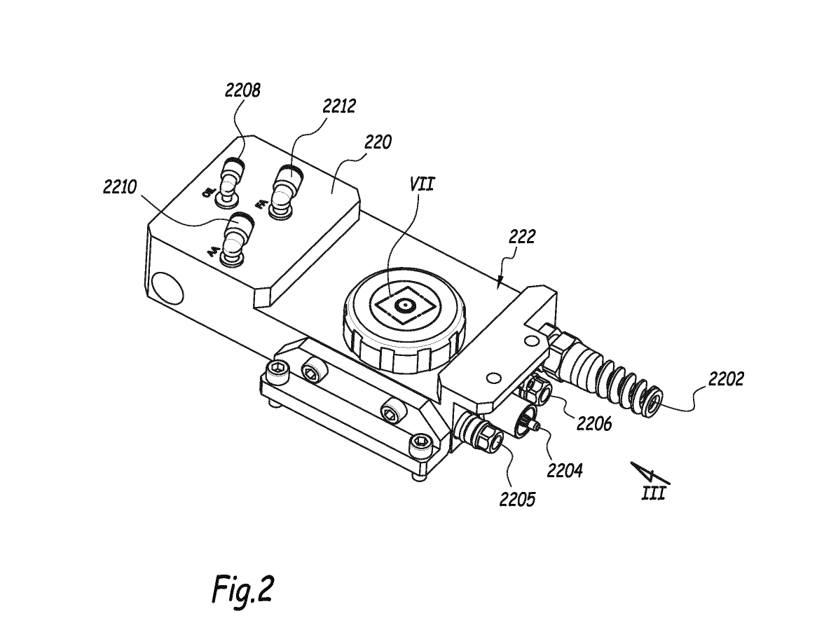

FIG. 2 is a perspective view of a modular atomizer according to the invention and belonging to the facility of FIG. 1 associated with a parent block,

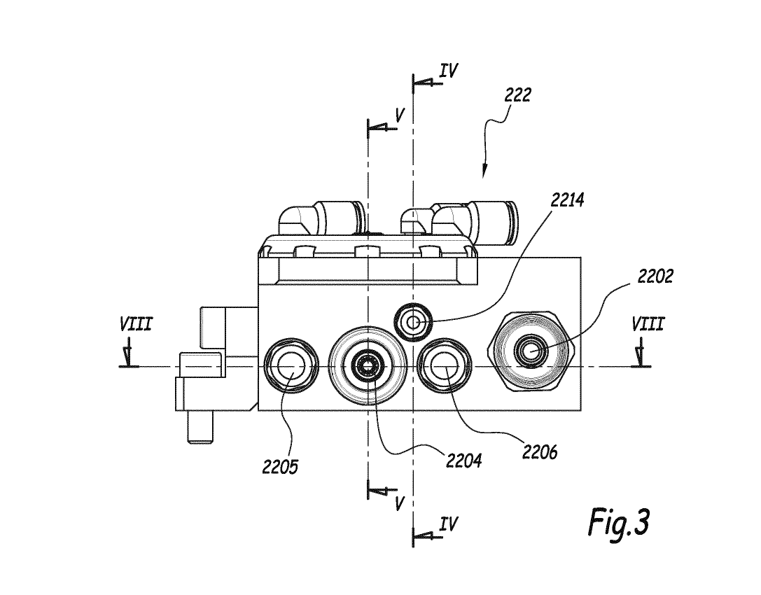

FIG. 3 is a view along the arrow III of FIG. 2,

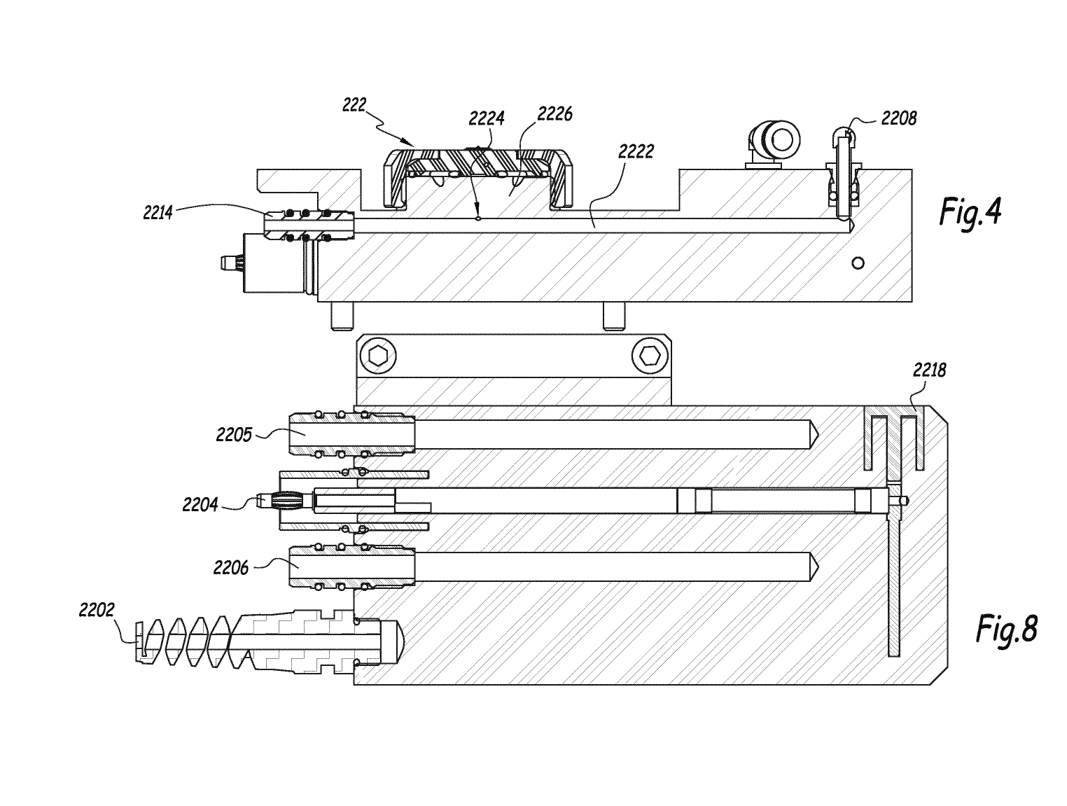

FIG. 4 is a sectional view along the line IV-IV of FIG. 3,

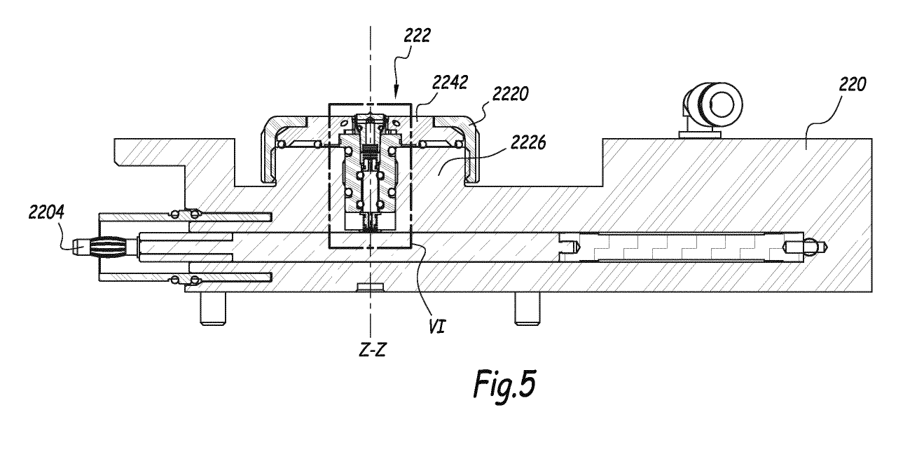

FIG. 5 is a sectional view along the line V-V of FIG. 3,

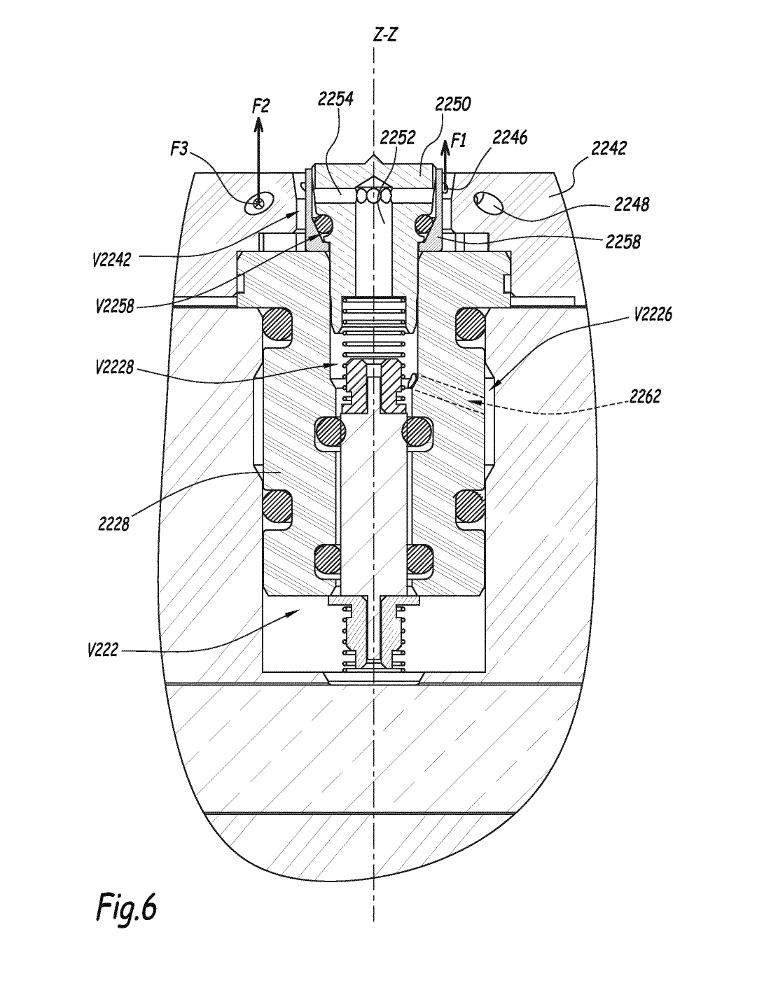

FIG. 6 is a larger scale view of the box VI of FIG. 5,

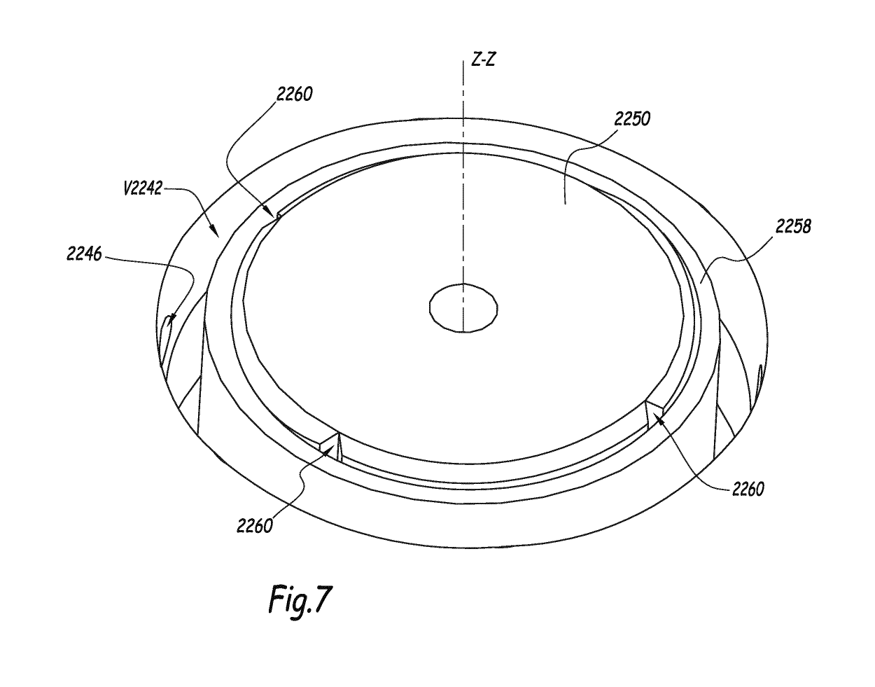

FIG. 7 is a larger scale view of the box VII of FIG. 2,

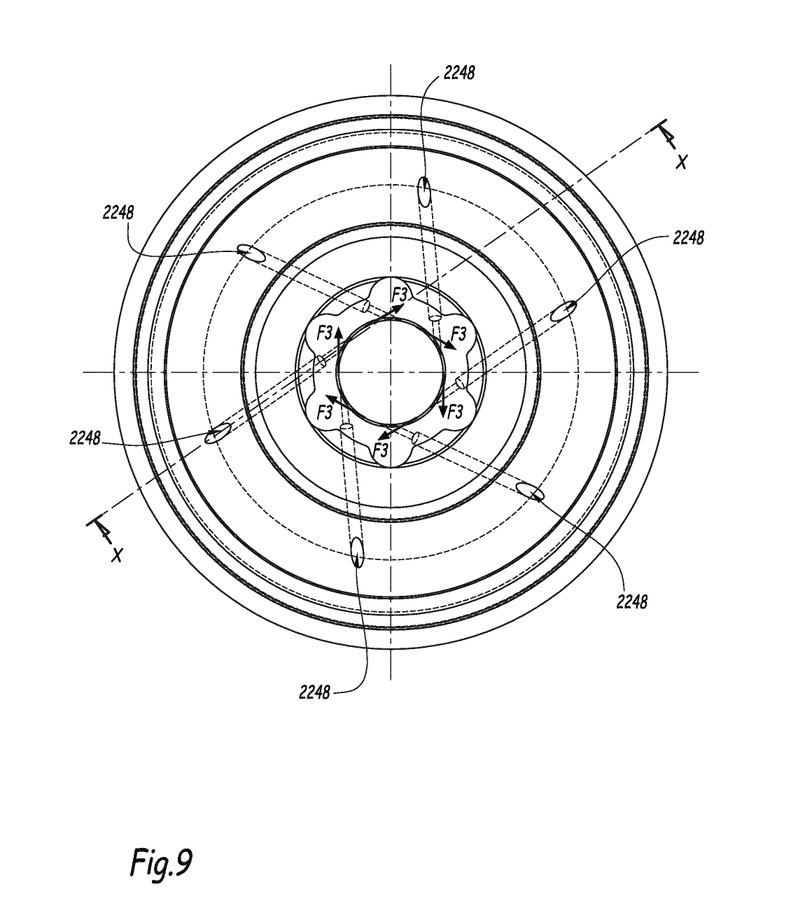

FIG. 8 is a sectional view along the line VIII-VIII of FIG. 3,

FIG. 9 is an elevational view of a body of the atomization module of FIG. 2, and

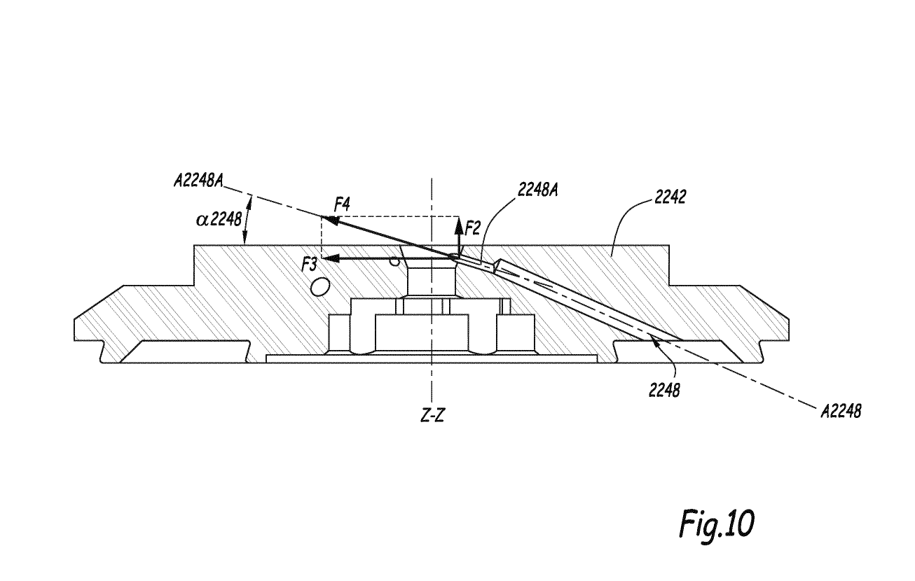

FIG. 10 is a sectional view along the line X-X of FIG. 9.

FIG. 1 shows a facility 2 for lubricating a part via an electrostatic route. In this example, oil is used as a lubricant. The facility 2 comprises a confinement chamber 20 which gives the possibility of cleaning up the environment in the workshop, recovering and entirely recycling the lubricant which would not have attained the part(s) to be treated. For this purpose, the installation 2 comprises a pipe not shown, giving the possibility of draining the lubricant remaining inside the confinement chamber 20 towards the outside. This chamber 20 further prevents any external pollution and facilitates the transport of the oil droplets.

Inside the confinement chamber 20, are positioned several parts 26 intended to be lubricated. In practice, the parts 26 cover a path along a direction perpendicular to the plane of FIG. 1 and along which several types of atomizer are installed. For example, a water atomizer may be used for cooling conformation tools and a liquid paint or varnish sprayer may then be used for coating the part with a paint or varnish layer. As an alternative not shown, a single wide part crosses the facility 2.

Above and below the parts 26 are positioned two modular atomizers 22 and 24. A modular atomizer is an atomizer which comprises several modules all supplied through a same supply line. In the following of the description, only the atomizer 22 is detailed in so far that the atomizers 22 and 24 are identical.

The modular atomizer 22 comprises two modules 222 and 223 and a parent block 220. The parent block 220 is a block which supplies with lubricant and air the modules 222 and 223 of the atomizer 22. In practice, a spraying assembly may contain up to five modules and two spraying assemblies therefore include 10 modules which give the possibility of spraying the lubricant on a part 26 with a length equal to about 1 meter. The parent block 220 is therefore connected through pipes 28 to a lubricant supply block 25. Moreover, the parent block 220 is also connected through electric cables 21 to a unit for producing a high voltage 23. This gives the possibility of applying high voltage to the lubricant. The unit for producing the high voltage 23 and the product and air supply block 25 are each connected to an electro-pneumatic control box 27.

The box 27 is pneumatically connected to the atomizers 22 and 24, by means of air pipes not shown.

In the diagram of FIG. 1, the parent block 220 only includes an input socket for the pipe 28 and an input socket for the cable 21, while in reality the latter further includes an air supply intake. Indeed, an atomizer of this type is designed for having a very low oil flow rate at the outlet of the atomizer, for example of less than 1 cm³/min. Thus, the oil velocity at the output is too low for forming a jet having a sufficient length for attaining the part. This is why a first air injection circuit is used, which opens at the outlet on a passage which will cap the oil outlet, in order to detach and accelerate the oil droplets arriving at the outlet of the atomizer. By spraying the oil as droplets, it is possible to obtain a more accurate impact and improved yield.

The facility 2 further comprises a system for regulating the product and air flow rate, not shown in FIG. 1 but which is located upstream from the product and air supply block 25. The flow rate regulation system gives the possibility of reducing the oil consumption and making a correction according to the temperature at which the lubrication method is carried out.

Moreover, an electrostatic field is established between the atomizer 22 and the parts 26 to be treated which are grounded. Indeed, as the spraying air pressures are low, the aeraulic forces are not sufficient and their direction is not necessarily well oriented for properly projecting the jet towards the parts 26 to be treated. This is why an electrostatic field is used, which is protected by the confinement chamber 20, for guiding the oil droplets as far as the parts 26 to be lubricated. This guidance occurs since these droplets are charged according to a same polarity.

As visible in FIGS. 2 and 3, the parent block 220 comprises at the inlet, an oil supply intake 2208, two air supply intakes 2210 and 2212 and a high voltage input terminal 2202. Each intake 2210 and 2212 supplies a different air circuit. At the outlet of the modular atomizer 22, are positioned a high voltage output terminal 2204, an oil connection socket 2214 and two air connection sockets 2205 and 2206. In the present case, these sockets 2204, 2206 and 2214 are connected to the second module 223 of the atomizer 22. For an atomizer with a single module, these sockets are each covered with a plug.

As visible in FIG. 4, the oil circulates from the socket 2208 and then through a supply line 2222 of the different modules of the atomizer 22. At the module 222, on the supply line 2222, the presence of a hole 2224 is noted, which indicates that the oil circulating in the line is deviated via this hole 2224 in order to attain the spraying module 222 through a conduit which is located in a plane different from the one of FIG. 4. The supply line 2222 opens at the outlet on the second module 223 of the atomizer 22, which is not shown, in FIGS. 2 and subsequently, for the sake of clarity of the drawing.

As illustrated in FIG. 5, the spraying module 222 extends along an axis Z-Z which is an axis for spraying the lubricant. This module 222 comprises a nozzle 2242 attached by a nut 2220 on a support 2226 of the atomizer 22. This support 2226 comprises a housing V222 for receiving the module 222 of the atomizer 22.

In the following of the description, the direction “up” is defined as an oriented direction in the direction of the injection and the direction “bottom” as an oriented direction in the direction opposite to the injection. The injection is therefore accomplished from bottom to top.

The module 222 is fitted into the inside of the support 2226. Inside the housing V222 for receiving the module 222, is located an oil admission chamber V2226. A conduit not shown gives the possibility of conveying the oil from the hole 2224 of the distribution line 2210 as far as this chamber V2226. A hollow body 2228 is positioned inside this chamber V2226. The interior volume of the body 2228 extends along the axis Z-Z. Channels 2262, a single one of which is illustrated in dotted lines in FIG. 6, cross this hollow body 2228 radially to the spraying axis Z-Z. The oil contained in the chamber V2226 therefore takes the channels 2262 for crossing the hollow body 2228 and arrives into a second chamber V2228.

This second chamber V2228 communicates with a cavity 2252 formed in a core 2250 located at the top of the module 222. The core 2250 also includes four perforated holes 2254 crossing the cavity 2252 each according to a radial direction to the spraying axis Z-Z. The pressure of the oil is such that the latter moves up through the cavity 2252 and escapes through the holes 2254.

Around the core 2250 is located an injection ring 2258. The oil therefore arrives, through the perforated holes 2254, in a volume V2258 located between the injection ring 2258 and the core 2250 and then passes between the injection ring 2258 and the core 2250. The core 2250 and the injection ring 2258 are axisymmetrical parts around the axis Z-Z.

As visible in FIG. 7, the core 2250 comprises four grooves 2260 with a triangular section, which extend parallel to the spraying axis Z-Z. The ring 2258 encircles the top portion of the core 2250, which causes the grooves 2260, three of which are visible in FIG. 7, to form disconnected passage sections for the oil and are regularly distributed around the axis Z-Z. The radial dimension of the grooves 2260 is small, in practice it is less than 0.5 mm, preferably of the order of 0.2 mm and they are only visible in FIG. 7. An oil flow rate of less than about 1 cm³/min is thereby obtained.

The passage sections 2260 form together a passage surface for the oil around the core 2250, which is centered on the spraying axis Z-Z.

As opposed to a passage of the oil through a complete ring-shaped surface, by using an interrupted passage surface it is possible to reduce the flow rate at the outlet of the spraying module 222.

As this is apparent from FIGS. 6 and 7, the module 222 of the atomizer 22 comprises, around the injection ring 2258, an air ejection tubular space V2242 which communicates with holes 2246 for conveying the air from the inlet terminal 2210. The air ejected from the volume V2242 forms a straight air jet which caps the passage sections 2260 of the lubricant. In other words, the space V2242 is an air ejection passage along an axial direction F1 parallel to the spraying axis Z-Z. The tubular passage V2242 is located as close as possible to the passage sections 2260 of the lubricant so as to detach the oil drops leaving the grooves 2260 of the core 2242.

Around the passage space V2242, is made another air ejection passage, which is formed by several holes 2248 regularly distributed around the axis Z-Z in the nozzle 2242. In other words, the holes 2248 form an air ejection passage, which is laid out around a passage space V2242 and around sections 2260, along a peripheral direction to the spraying axis Z-Z. These holes 2248 are better visible in FIGS. 9 and 10 in so far that only the nozzle 2242 is illustrated in these figures.

More specifically, the nozzle 2242 comprises six holes 2248, which extend from a lower aperture as far as an upper aperture, during operation, the air is ejected from the holes 2248 along a helical direction F4. Indeed, this direction F4 has an axial component F2 which is parallel to the axis Z-Z and a component F3 which is ortho-radial to the spraying axis Z-Z. The components F2 and F3 are non-zero. The angle formed by the direction F4 with an axis perpendicular to the axis Z-Z is noted as α2248, this angle in practice being comprised between 10° and 60°, or equal to 17°. The value of the α2248 angle determines the intensity with which the droplets are driven into rotation.

With reference to FIG. 10, the holes 2248 extend along an axis A2248 as far as an end 2248A. The air injected into the holes 2248 is therefore propelled at the outlet along an axis A2248A which corresponds to the axis on which the end 2248A is centered. The axis A2248A coincides with the direction F4.

As visible in FIGS. 9 and 10, all the air jets flowing out of the holes 2248 have their ortho-radial component F3 oriented in the same direction, here in the clockwise direction in the plane of FIG. 9.

The oil droplets are driven into rotation around the axis Z-Z by air jets flowing out of the holes 2248. The oil droplets are therefore sprayed along a direction substantially helical around the axis Z-Z. This is referred to as a jet of the vortex type. By spraying the oil as a vortex jet, it is possible to stabilize, homogenize and ensure the continuity of the oil jet. This further allows limitation of the <<rebound>> or <<overspray>> phenomena at the jet.

As visible in FIG. 8, the input terminal of the high voltage 2202 opens onto an electrically conducting element 2216 which is a metal bar. Although this is not visible in the figures, this bar 2216 plays the role of a charging electrode for the lubricant.

Alternatively, it is possible to use a number of grooves 2260 different from four.

According to another alternative not shown, the atomizer does not use any electrostatic field for channeling the jet.

According to another alternative not shown, the grooves 2260 are machined with a section other than a triangular section, notably with a semi-circular section.

According to another alternative not shown, the air ejection passage intended to drive the lubricant into rotation is not formed by disconnected holes 2248, but by a chamber into which is injected, both the air along an axial direction and air along an ortho-radial direction. The mixture of these two air flows results in the formation of a whirling tubular air sheet. Further, it is possible to equip the atomizer 22 with a flow rate regulator giving the possibility of regulating the <<axial>> air flow rate relatively to the <<ortho-radial>> air flow rate. Thus, a larger flow rate of <<axial>> air provides better acceleration of the lubricant jet while a larger <<radial>> air flow rate provides better stability of the lubricant jet.

According to another embodiment not shown, the core 2250 is without any grooves 2260 and it is the injection ring 2258 which includes internal grooves defining the passage sections for the oil.

According to an advantageous aspect of the invention, and with the purpose of reducing the lubricant flow rate without further modifying the atomizers 22 and 24, the supply block 25 incorporates a piezoelectric valve 252 which selectively interrupts the flow of the lubricant towards the atomizers, at a frequency which may vary between 10 and 200 Hz. Thus, trains of lubricant, potentially variable in frequency and in duration, are provided to the atomizers 22 and 24.

Alternatively, the valve 252 is of a type other than the piezoelectric type, for example a pneumatic or electromagnetic type.

The embodiments and alternatives mentioned above may be combined for giving rise to new embodiments of the invention.

1. An atomizer of a lubricant product along a spraying axis, comprising:
a first passage of the lubricant product which is centered on the spraying axis,
a nozzle, which is centered on the spraying axis,
a core which is coaxially positioned inside the nozzle,
a second passage for ejecting a first air jet, which is arranged around the first passage along a peripheral direction to the spraying axis, and which, during operation, imparts to the first air jet a helical direction,
wherein
the first passage is defined between the core and the nozzle and is formed with several disconnected passage sections,
the atomizer further comprises a ring which at least partly clasps the core, and
the passage sections of the lubricant product are formed with grooves axially extending on the periphery of the core or inside the ring.

2. The atomizer according to claim 1, wherein the passage sections have a radial dimension of less than 0.5 mm.

3. The atomizer according to claim 1, wherein the passage sections of the lubricant product are regularly distributed around the spraying axis.

4. The atomizer according to claim 1, wherein the passage sections are triangular.

5. (canceled)

6. The atomizer according to claim 1, wherein the atomizer comprises a third passage for ejecting a second air jet, which is positioned between the ring and the nozzle.

7. The atomizer according to claim 6, wherein the third passage is tubular so that, during operation, the third passage gives the second air jet an axial direction.

8. The atomizer according to claim 1, wherein the second air passage is formed with holes which are regularly distributed around the spraying axis and which, during operation, give the first air jet a direction comprising an axial component and an ortho-radial component to the spraying axis.

9. The atomizer according to claim 1, wherein an electrically conducting element positioned in contact with the lubricant product and is powered up during the operation of the atomizer.

10. A facility for lubricating a part, comprising:
a confinement chamber,
a block for supplying a lubricant product,
an electropneumatic control box, and
at least one atomizer according to claim 1.

11. The facility according to claim 10, wherein the block for supplying a lubricant product is equipped with a valve for interrupting a flow of the lubricant product towards the atomizer at a frequency comprised between 10 and 200 Hz.
